(19) United States
(12) Patent Application Publication
(10) Pub. No.: US 2006/0172174 A1
(43) Pub. Date: Aug. 3, 2006

(54) Fuel cell system

(76) Inventors: In Hyuk Son, Yongin (KR); Dong Myung Suh, Yongin (KR); Ju Yong Kim, Seoul (KR)

Correspondence Address: CHRISTIE, PARKER & HALE, LLP, PO BOX 7068, PASADENA, CA, 91109-7068, US

(21) Appl. No.: 11/366,696

(22) Filed: Mar. 1, 2006

(30) Foreign Application Priority Data
Feb. 3, 2005 (KR) 10-2005-17405

(51) Int. Cl. H01M 8/04; H01M 8/06

(52) U.S. Cl. 429/34; 429/19; 429/26

(57) ABSTRACT

A fuel cell system including a stack provided with a plurality of unit cells generating electricity based on a chemical reaction between hydrogen gas and oxygen gas, and a reformer for supplying the hydrogen gas obtained by reforming hydrogen-containing fuel to the stack. A fuel storage tank is provided for storing the hydrogen-containing fuel to be supplied to the reformer and an air supplier is provided for supplying air to the stack. An injection nozzle assembly is detachably provided and includes an injection means placed in front of the inlet formed in the first side of the reformer to introduce the hydrogen-containing fuel from the fuel storage tank.

### CROSS-REFERENCE TO RELATED APPLICATIONS

This application claims the benefit of Korean Patent Application No. 2005-17405, filed on Mar. 2, 2005, in the Korean Intellectual Property Office, the entire disclosure of which is incorporated herein by reference.

### BACKGROUND

1. Field of the Invention

The present invention relates to a fuel cell system for generating electricity through an electrochemical reaction between hydrogen and oxygen.

2. Discussion of Related Art

To solve environmental or lack of natural resources problems, much attention has been paid to a fuel cell that electrochemically reacts oxygen in air with hydrogen obtained by reforming hydrogen-containing fuel including a hydro-carbonaceous material such as methanol, ethanol, natural gas, etc., thereby generating electricity. Such fuel cell is classified into a phosphoric acid fuel cell (PAFC), a molten carbonate fuel cell (MCFC), a solid oxide fuel cell (SOFC), a polymer electrolyte membrane fuel cell (PEMFC), an alkaline fuel cell (AFC), etc. according to the electrolyte used. These fuel cells may be applied to various fields such as a mobile device, transportation, a distributed power source, etc. according to a kind of fuel, a driving temperature, an output range, etc.

Among these fuel cells, the PEMFC has benefits including excellent output performance; low operation temperature; and quick start and response. Therefore, the PEMFC has been actively researched. The PEMFC includes a stack in which a plurality of unit cells generating electricity based on a chemical reaction between hydrogen gas and oxygen gas is stacked and a reformer reforming the hydrogen-containing fuel, generating hydrogen gas, and supplying the hydrogen gas to the stack. The PEMFC also includes a fuel feeder for feeding the reformer with the hydrogen-containing fuel and an air supplier for supplying air to the stack. The fuel feeder includes a fuel tank to store the hydrogen-containing fuel therein, and a fuel pump to supply the hydrogen-containing fuel from the fuel tank to the reformer.

As the fuel pump operates, the hydrogen-containing fuel is supplied from the fuel tank to the reformer, and the reformer reforms the supplied hydrogen-containing fuel, thereby generating hydrogen gas. The generated hydrogen gas is supplied to the stack, and then chemically reacts with oxygen in air, thereby generating electricity. Then, the electricity is supplied to an external circuit via an electric collector.

However, in a conventional PEMFC, the fuel pump causes problems of noise, vibration and much power consumption when it is operated to smoothly supply the hydrogen-containing fuel to the reformer.

### SUMMARY OF THE INVENTION

Accordingly, a fuel cell system is provided in which hydrogen-containing fuel is supplied from a fuel tank to a reformer through an injection nozzle assembly having an injection means without using a fuel pump, thereby reducing noise, vibration and power consumption normally contributed to a fuel pump.

The fuel cell system includes: a stack provided with a plurality of unit cells generating electricity based on a chemical reaction between hydrogen gas and oxygen gas; a reformer for supplying the hydrogen gas obtained by reforming hydrogen-containing fuel to the stack; a fuel storage tank for storing the hydrogen-containing fuel to be supplied to the reformer; an air supplier for supplying air to the stack; and an injection nozzle assembly provided for fluid communication between the fuel storage tank and the reformer. The injection nozzle assembly includes a housing that defines a fuel chamber to accommodate the hydrogen-containing fuel supplied from the fuel storage tank, the housing having a first side formed with an outlet through which the hydrogen-containing fuel accommodated in the fuel chamber is discharged, and an injection means provided in the fuel chamber.

According to exemplary embodiments of the invention, the injection means may include a vibration plate, a piezo actuator, a heater or a heating means provided in the housing. Additionally, the fuel cell system may further include a reforming catalytic layer coated on the inside of the housing as well as the inside of the outlet. The fuel cell system may also include a heating means provided in the housing to heat the hydrogen-containing fuel stored in the fuel chamber. The housing may include a connection pipe, and the injection means may have a heating plate generating gas bubbles in the hydrogen-containing fuel within the connection pipe.

### BRIEF DESCRIPTION OF THE DRAWINGS

FIG. 1 is a block diagram of a fuel cell system according to an exemplary embodiment of the present invention.

FIG. 2 illustrates an injection nozzle assembly according to a first embodiment of the present invention.

FIG. 3 illustrates that the injection nozzle assembly of FIG. 2 is installed in front of a reformer.

FIGS. 4A and 4B illustrate that the injection nozzle assembly of FIG. 2 having another injection means is installed in front of the reformer.

FIGS. 5A and 5B illustrate that the injection nozzle assembly of FIG. 2 having a third injection means is installed in front of the reformer.

FIGS. 6A-6C illustrate that the injection nozzle assembly of FIG. 2 having a fourth injection means is installed in front of the reformer.

FIGS. 7A and 7B illustrate an injection nozzle assembly according to another exemplary embodiment of the present invention.

FIG. 8 illustrates that the injection nozzle assembly of FIG. 7B is installed in front of the reformer.

FIGS. 9A and 9B illustrate that the injection nozzle assembly of FIG. 7B having another injection means is installed in front of the reformer.

FIGS. 10A and 10B illustrate that the injection nozzle assembly of FIG. 7B having a third injection means is installed in front of the reformer.

FIGS. 11A-11C illustrate that the injection nozzle assembly of FIG. 7B having a fourth injection means is installed in front of the reformer.

### DETAILED DESCRIPTION

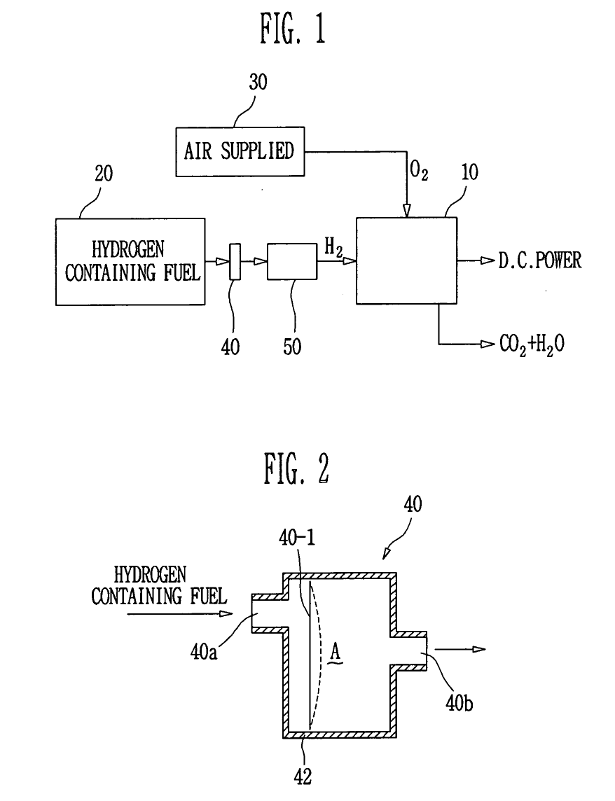

A fuel cell system according to an embodiment of the present invention is applied to a PEMFC that reforms hydrogen-containing fuel including a hydro-carbonaceous material such as methanol, ethanol, natural gas, etc., and supplies hydrogen gas to a stack, thereby generating electricity. As shown in FIG. 1, such a PEMFC includes a stack 10 provided with a plurality of unit cells generating electricity based on a chemical reaction between hydrogen gas and oxygen gas and a reformer 50 supplying hydrogen gas obtained by reforming hydrogen-containing fuel to the stack 10. The PEMFC also includes a fuel storage tank 20 storing the hydrogen-containing fuel to be supplied to the reformer 50 and an air supplier 30 supplying air to the stack 10.

Referring to FIG. 3, the stack 10 is provided with a plurality of unit cells including a membrane electrode assembly (MEA) 14 having a polymer membrane 14a and electrodes 14b, 14c provided on opposite sides of the polymer membrane 14a, and division plates provided on opposite sides of the MEA 14 to supply hydrogen gas and oxygen gas. Here, the division plate may be a bipolar plate 16, which is interposed between neighboring MEAs 14, the bipolar plate 16 having a first side formed with a channel for supplying hydrogen gas and a second side formed with a channel for supplying oxygen gas, but is not limited thereto.

In the MEA 14, the electrodes include an anode electrode 14b generating a hydrogen ion (H⁺) and an electron (e⁻) by oxidizing hydrogen gas supplied from the reformer 50, and a cathode electrode generating water through oxygen reduction. The anode electrode 14b includes a catalytic layer provided to face the first side of the bipolar plate 16 and dissociating the hydrogen gas supplied through the first side into hydrogen ions and electrons by oxidation; and a gas diffusion layer (GDS) to uniformly disperse the hydrogen gas on the catalytic layer and eject carbon dioxide generated by the oxidization process of the hydrogen gas. Similarly, the cathode electrode 14c includes a catalytic layer facing the second side of the bipolar plate 16 to facilitate a chemical reaction between oxygen in air supplied through the channel (not shown) formed on the second side and hydrogen ion, and a gas diffusion layer (GDS) to uniformly disperse the oxygen on the catalytic layer and eject water generated through the chemical reaction.

Further, the polymer membrane 14a, a conductive polymer electrolyte membrane having a thickness of between about 50 μm to 200 μm, has an ion exchange function to transfer hydrogen ions generated in the catalytic layer of the anode electrode 14b to the catalytic layer of the cathode electrode 14c. Examples of polymer membranes 14a include a perfluorinated fluoric acid resin membrane made of perfluorosulfonate resin (Nafion®), a membrane formed by coating a porous polytetrafluoroethylene thin film support with resin solution such as perfluorinated sulfonic acid or the like, and a membrane formed by coating a porous non-conductive polymer support with a positive ion exchange resin and inorganic silicate, etc.

The outermost portion of the stack 10 has end plates 12a, and 12b. The surfaces of the end plates 12a, 12b each facing the anode electrode 14b and the cathode electrode 14c are formed with a hydrogen gas channel and an oxygen gas channel adapted to allow hydrogen gas and oxygen gas to flow therethrough. The outer side of the first end plate 12a facing the anode electrode 14b includes a first inlet 10a through which the hydrogen gas is introduced, and an output terminal 10c for supplying direct current (DC) power resulting from the electrochemical reaction in the unit cells to the outside. Likewise, the outer side of the second end plate 12b facing the cathode electrode 14c includes a second inlet 10b through which air is introduced, and a discharging portion 10d for discharging carbon dioxide (CO₂) and water (H₂O) resulting from the electro-chemical reaction in the unit cells to the outside.

In the stack 10, the hydrogen gas inlet formed in the first side of the bipolar plate of a first unit cell is connected to and communicates hydrogen gas to the hydrogen gas inlet formed in the first side of the bipolar plate of a second unit cell. Similarly, the oxygen inlet formed in the second side of the bipolar plate of a first unit cell is connected to and communicates oxygen gas with the oxygen gas inlet formed in the second side of the bipolar plate of a second unit cell. Further, the first and second inlets 10a, 10b each formed in the end plates 12a, 12b are connected to and communicate hydrogen gas and oxygen gas with the hydrogen gas inlet formed in the first side of the bipolar plate and the oxygen gas inlet formed in the second side of the bipolar plate forming adjacent unit cells, respectively.

The reformer 50 is installed in front of the stack 10 and contains a reforming portion to reform hydrogen-containing fuel including the hydro-carbonaceous material such as methanol, ethanol, natural gas, etc., thereby generating hydrogen gas. Further, the reformer 50 contains a carbon monoxide filtering portion to remove harmful material such as carbon monoxide generated as a byproduct.

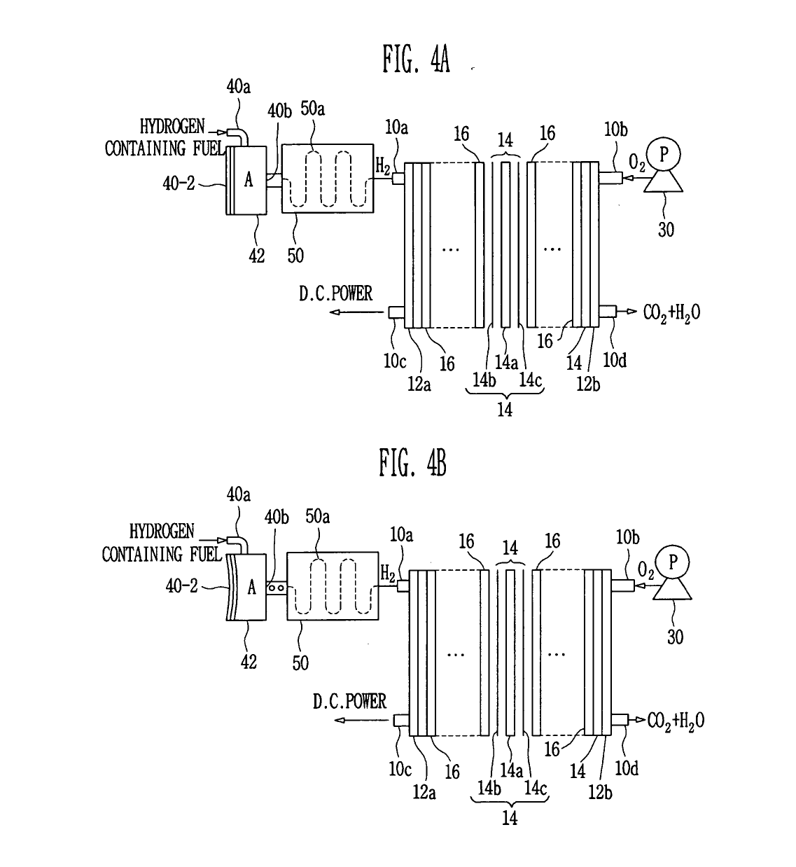

The reforming portion of the reformer 50 reforms the hydrogen-containing fuel into hydrogen gas through a catalyst reaction such as Steam Reforming, Partial Oxidation, Auto-Thermal Reaction, etc. As such, the reforming portion includes an inlet to receive the hydrogen-containing fuel and an outlet to discharge the hydrogen gas obtained by reforming the hydrogen-containing fuel to the stack 10. Further, a channel 50a (FIG. 4a) is provided between the inlet and outlet in which the hydrogen-containing fuel is flowed, vaporized and reformed. The carbon monoxide filtering portion removes carbon monoxide from the hydrogen gas generated in the channel 50a through a catalyst reaction such as Water Gas Shift Reaction and Preferential Oxidation Reaction, or through hydrogen purification using a division membrane.

According to an exemplary embodiment of the present invention, the PEMFC further includes an injection nozzle assembly 40 installed adjacent the inlet of the reformer 50 for injecting hydrogen-containing fuel from the fuel storage tank 20 to the reformer 50. Here, the injection nozzle assembly 40 is internally provided with an injection means 40-1 through 40-4 (to be described later, but not limited to).

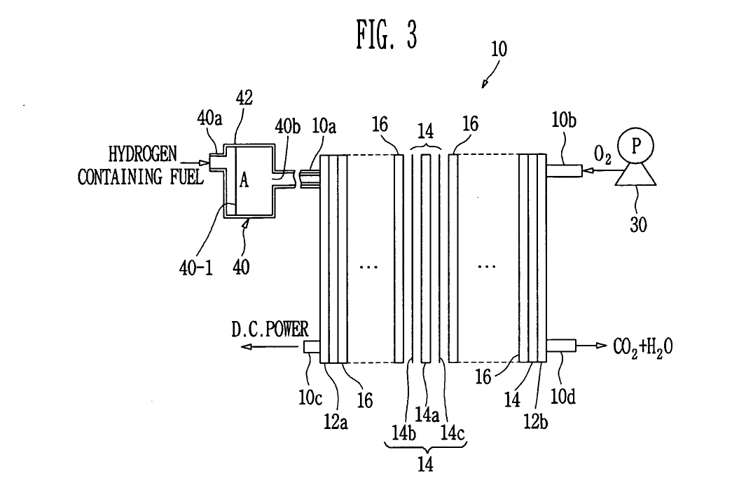

Referring to FIG. 2, the injection nozzle assembly 40 includes a housing 42 to define a fuel chamber A to accommodate the hydrogen-containing fuel. The housing 42 has a first side formed with an inlet 40a to introduce hydrogen-containing fuel from the fuel storage tank 20 into the fuel chamber A; and a second side formed with an outlet 40b to discharge hydrogen-containing fuel from the fuel chamber A to the reformer 50.

To discharge hydrogen-containing fuel from the fuel chamber A to the reformer 50 through the outlet 40b, the fuel chamber A is provided with injection means. The injection means includes a vibration plate 40-1 which may be arched toward the outlet 40b and is vibrated by external power (FIG. 2). When the vibration plate 40-1 is arched, the hydrogen-containing fuel accommodated in the fuel chamber A adjacent to the outlet 40b is moved toward the outlet 40b and is discharged toward the reformer 50. Simultaneously, hydrogen-containing fuel is introduced from the fuel storage tank 20 through the inlet 40a. The amount of hydrogen-containing fuel introduced through the inlet 40a into the fuel chamber A is proportional to the amount of the hydrogen-containing fuel discharged through the outlet 40b.

When the external power is off, the vibration plate 40-1 returns to an initial unarched state and hydrogen-containing fuel introduced through the inlet side of the vibration plate 40-1 is moved toward the outlet side of the vibration plate 40-1 through a bypass channel (not shown), thereby being accommodated in the fuel chamber A.

As the power alternates between on and off, the vibration plate 40-1 is vibrated, and correspondingly the hydrogen-containing fuel accommodated in the fuel chamber A is controlled to flow out through the outlet 40.

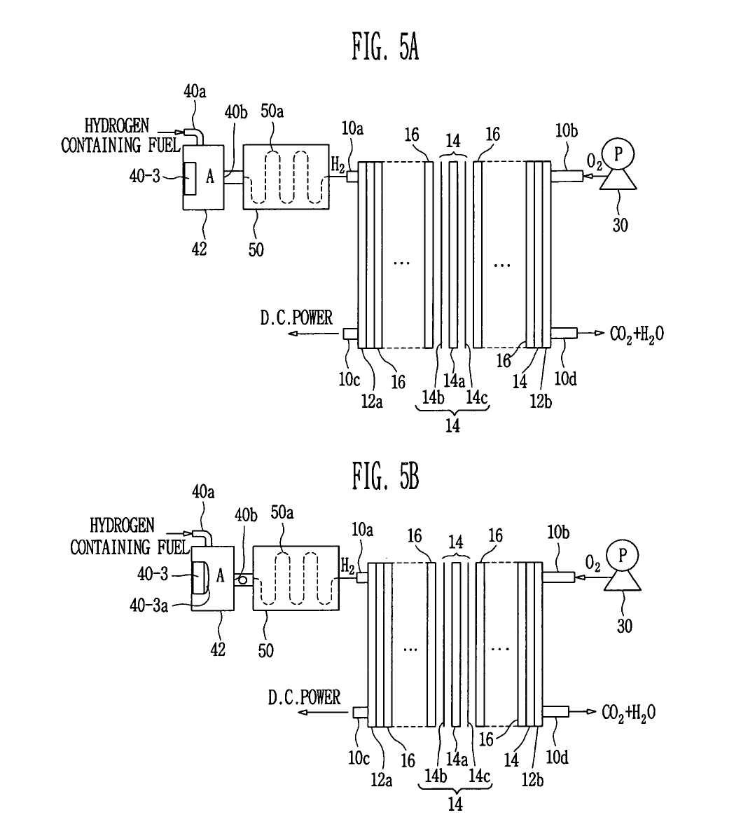

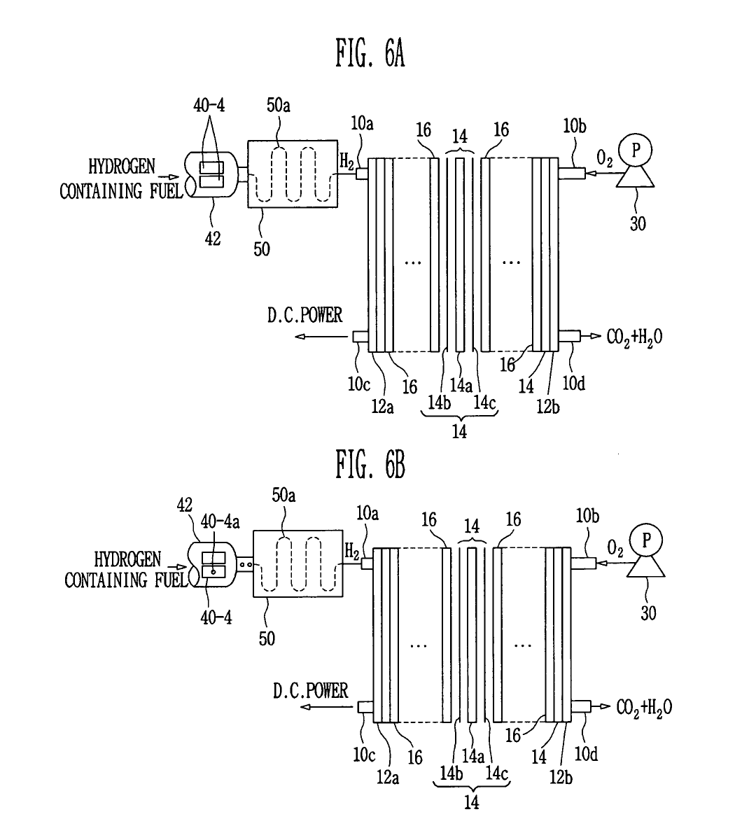

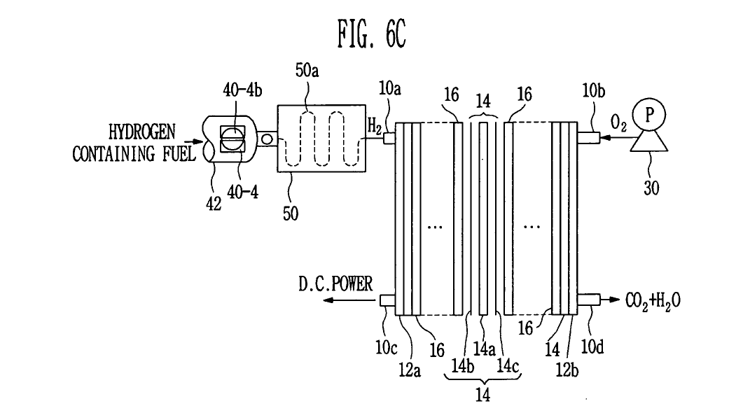

However, the injection means of the injection nozzle assembly is not limited to the vibration plate 40-1. The injection means may also include a deformable piezo-actuator 40-2 (FIGS. 4A-4B), a heater 40-3 (FIGS. 5A-5B), or a heating plate 40-4 (FIGS. 6A-6C), which is heated when the external power is supplied thereto.

Referring to FIGS. 4A-4B, the piezo actuator 40-2 is deformed as external power is applied thereto, and correspondingly the hydrogen-containing fuel accommodated in the fuel chamber A is discharged toward the reformer through the outlet 40b. The amount of hydrogen-containing fuel introduced from the fuel storage tank 20 into the fuel chamber A through the inlet 40a is proportional to the amount of hydrogen-containing fuel discharged through the outlet 40b.

Referring to FIGS. 5A-5B, the heater 40-3 is quickly heated when external power is applied thereto, and thus hydrogen-containing fuel accommodated in the fuel chamber A generates gas bubbles 40-3a. Due to the expansion of the gas bubbles 40-3a, the hydrogen-containing fuel accommodated in the fuel chamber A is discharged toward the reformer 50 through the outlet 40b. The amount of hydrogen-containing fuel introduced from the fuel storage tank 20 into the fuel chamber A through the inlet 40a is proportional to the amount of hydrogen-containing fuel discharged through the outlet 40b.

Referring to FIG. 6A-6C, the heating plate 40-4 is heated when the external power is applied thereto, and thus the hydrogen-containing fuel accommodated in the fuel chamber A expands and generates gas bubbles 40-4a, 40-4b. Therefore, hydrogen-containing fuel is discharged to the reformer 50 through the outlet 40b based on the volume increase caused by the generated gas bubbles 40-4a, 40-4b. On the other hand, as the heating plate 40-4 cools when the external power is off, hydrogen-containing fuel is introduced from the fuel storage tank 20 to the fuel chamber A based on the reduced volume thereof.

Below, operation of the fuel cell system according to an exemplary embodiment of the present invention will be described.

The reformer 50 is provided to supply hydrogen gas adjacent the first inlet 10a of the stack 10 having one or more unit cells, and the injection nozzle assembly 40 is provided between the reformer 50 and the fuel storage tank 20 to allow flow communication between the fuel storage tank 20 and the reformer 50. The second inlet 10b of the stack 10 is connected to the air supplier 30, e.g., an air pump for supplying air.

As the injection means 40-1, 40-2, 40-3, or 40-4 is operated, hydrogen-containing fuel accommodated in the fuel chamber A is injected to the reformer 50 through the outlet 40b of the injection nozzle assembly 40. The hydrogen-containing fuel is vaporized and reformed into hydrogen gas flowing along the channel 50a of the reformer 50. The hydrogen gas is introduced into the first inlet 10a of the stack 10 through the outlet of the reformer 50.

The hydrogen gas is supplied to the anode electrode 14b of the MEA 14 through a hydrogen gas inlet (not shown) and a hydrogen gas channel (not shown) formed in the first side of the bipolar plate 16 as well as through the hydrogen gas channel formed in the first end plate 12a. Thereafter, the hydrogen gas is dissolved into hydrogen ions (protons) and electrons through the following oxidation (1) in the catalytic layer of the anode electrode 14b.
H₂(g)>2H⁺+2e⁻ (1)

As the air pump 30 is operated, oxygen gas in the air is supplied to the cathode electrode 14c of the MEA 14 through an oxygen gas inlet (not shown) and an oxygen gas channel (not shown) formed in the second side of the bipolar plate 16 as well as through the oxygen gas channel formed in the second end plate 12b. Thereafter, the oxygen gas is dissolved into oxygen ions and electrons.

The hydrogen ions generated in the anode electrode 14b are transferred to the cathode electrode 14c through the polymer membrane 14a, and then react with the oxygen ions generated in the cathode electrode 14c and electrons through the following oxygen reduction (2), thereby generating water.
2H⁺+(½)O₂(g)+2e⁻→H₂O(g) (2)

Then, the generated water along with carbon dioxide or the like generated in the stack 10 is discharged to the outside through the discharging portion 10d provided in the second end plate 12b. Further, the electrons generated in the anode electrode 14b are collected in the electric collector (not shown), and then discharged to the outside through the output terminal 10c provided in the first end plate 12a.

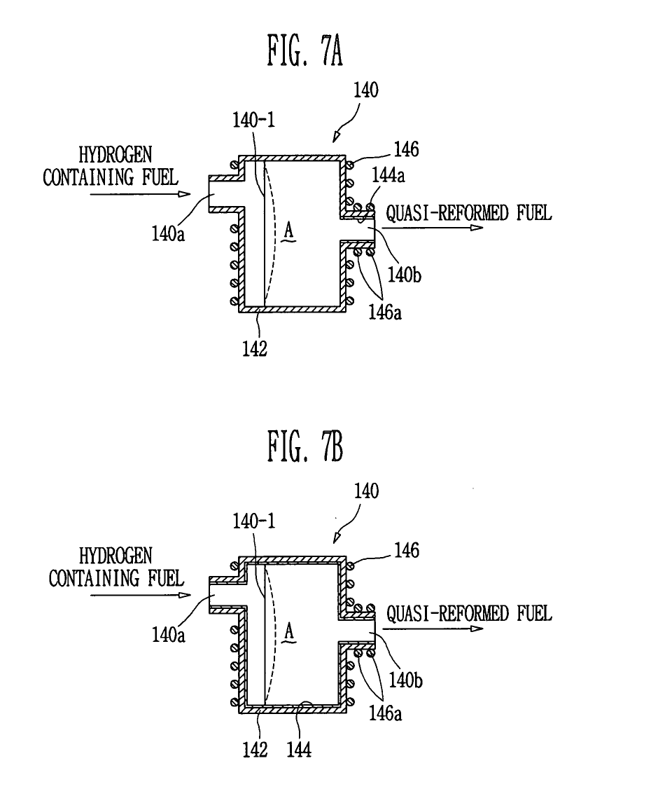

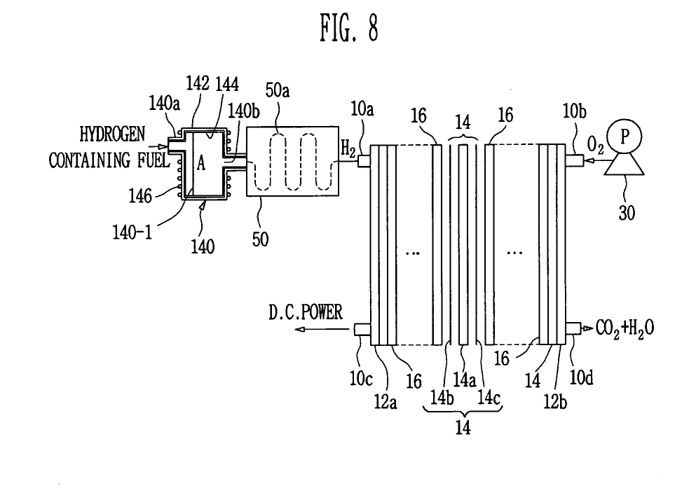

Referring to FIGS. 7A-7B, the PEMFC according to another exemplary embodiment of the present invention includes an injection nozzle assembly 140 formed with a first reforming catalytic layer 144a coated on an inside of an outlet 140b and/or a second reforming catalytic layer 144 coated on an inside of a housing 142.

To facilitate reforming the hydrogen-containing fuel in the following process of the reformer 50, as shown in FIG. 7A, the inside of the outlet 140b is coated with the first reforming catalytic layer 144a to quasi-reform the hydrogen-containing fuel discharged from the fuel chamber A through the outlet 140b. As used herein, a “quasi-reformed” state means a state where hydrogen-containing fuel has been processed to easily generate hydrogen gas. Therefore, when the injection means, e.g., a vibration plate 140-1 is vibrated, the hydrogen-containing fuel transformed into a quasi-reformed state is discharged as quasi-reformed fuel from the fuel chamber A through the outlet 140b. In one exemplary embodiment, a heating means 146a is provided around the outlet 140b to heat the hydrogen-containing fuel discharged through the outlet 140b, thereby facilitating the quasi-reforming transformation using the first reforming catalytic layer 144a of the outlet 140b.

To further facilitate reforming the hydrogen-containing fuel in the reformer, as shown in FIG. 7B, the inside of the housing 142 is coated with a second reforming catalytic layer 144 to transform the hydrogen-containing fuel accommodated in the fuel chamber A into a quasi-reforming state. Therefore, the hydrogen-containing fuel accommodated in the fuel chamber A is transformed into the quasi-reforming state by the quasi-reforming effect of the second reforming catalytic layer 144. Further, when the vibration plate 140-1 is vibrated, the hydrogen-containing fuel transformed into the quasi-reforming state is discharged as the quasi-reformed fuel through the outlet 140b of the housing 142, thereby easily reforming the hydrogen-containing fuel in the following process.

A heating means 146 may be provided around the housing 142 to heat the hydrogen-containing fuel accommodated in the fuel chamber A, thereby facilitating the quasi-forming transformation using the second reforming catalytic layer 144 of the fuel chamber A.

The first reforming catalytic layer 144a and the second reforming catalytic layer 144 are formed by coating the insides of the outlet 140b and the housing 142 with at least one catalytic material such as a Nobel metal catalytic material such as Pt, Pd, Ru, Rh or Ir, or from a base metal catalytic material such as Cu, Cr, Mo, W or Co.

The foregoing heating means 146, 146a may be configured as a hot wire or the like surrounding the housing and the outlet 140b, but not limited to. Therefore, the hydrogen-containing fuel accommodated in the fuel chamber A and/or the hydrogen-containing fuel discharged through the outlet 140b is heated by respective heating means 146, 146a. Thus, the heated hydrogen-containing fuel is easily transformed into quasi-reformed fuel by the quasi-reforming transformation using the first and second reforming catalytic layers 144, 144a.

The injection nozzle assembly 140 according to exemplary embodiments of the present invention has substantially the same structure as the injection nozzle assembly 40 shown in FIGS. 1-6C with the addition of the reforming catalytic layer 144, 144a and/or the heating means 146, 146a.

Below, operation of the PEMFC having the injection nozzle assembly 140 placed between the fuel storage tank 20 and the reformer 50 will be described with reference to FIGS. 8 through 11.

Referring to FIG. 8, the PEMFC according to this embodiment of the present invention includes a stack 10 provided with a plurality of unit cells generating electricity based on a chemical reaction between hydrogen gas and oxygen gas; a reformer 50 supplying hydrogen gas obtained by reforming hydrogen-containing fuel to the stack 10; a fuel storage tank 20 storing the hydrogen-containing fuel to be supplied to the reformer 50; and an air supplier 30 supplying air to the stack 10.

The stack 10 includes a plurality of unit cells including a membrane electrode assembly (MEA) 14 having a polymer membrane 14a and electrodes 14b, 14c provided on opposite sides of the polymer membrane 14a, and division plates provided on opposite sides of the MEA 14 to supply hydrogen gas and oxygen gas. Here, repetitive descriptions of previously described components will be avoided as necessary.

The reformer 50 is installed adjacent to the stack 10 and uses a reformer portion reforming the hydrogen-containing fuel including the hydro-carbonaceous material such as methanol, ethanol, natural gas, etc., thereby generating hydrogen gas. Further, the reformer 50 uses a carbon monoxide filtering portion to remove harmful material such as carbon monoxide generated as a byproduct.

The injection nozzle assembly 140 is provided between and communicates with the inlet of the reformer 50 and the fuel storage tank 20. The injection nozzle assembly 140 has a first side formed with an inlet 140a connected to and communicating with the fuel storage tank 20, and has a housing 142 to define the fuel chamber A accommodating the hydrogen-containing fuel supplied from the fuel storage tank 20 through the inlet 140a. The inside of the housing 142 is coated with the reforming catalytic layer 144 for transforming the hydrogen-containing fuel accommodated in the fuel chamber A into the quasi-reforming state. Further, the housing 142 is provided with the heating means to heat the hydrogen-containing fuel accommodated in the fuel chamber A. Also, the fuel chamber A employs the vibration plate 140-1 as the injection means, which is vibrated by the external power. Additionally, the fuel chamber A is formed with an outlet 140b facing the vibration plate 140-1 and discharging the hydrogen-containing fuel toward the inlet of the reformer 50.

Therefore, when an electric signal is transmitted from a controller (not shown) to the vibration plate 140-1, the vibration plate 140-1 is vibrated, discharging hydrogen-containing fuel accommodated in the fuel chamber A toward the inlet of the reformer 50 through the outlet 140b. Thus, the hydrogen-containing fuel is supplied to the inside of the reformer 50.

As the hydrogen-containing fuel is discharged, the hydrogen-containing fuel is supplied from the fuel storage tank 20 to the fuel chamber A by capillary and inertia effects or the like proportionally to the amount of the discharged hydrogen-containing fuel.

Hydrogen-containing fuel supplied to the reformer 50 is maintained in the quasi-reforming state by the quasi-reforming transformation of the reforming catalytic layer 144, so that the quasi-reformed fuel is more effectively reformed into the hydrogen gas while flowing in the channel 50a. The hydrogen gas generated in the reformer 50 is discharged to the stack 10 through the outlet thereof. Further, when a controller turns on heating means 146, the hydrogen-containing fuel accommodated in the fuel chamber A is heated, thereby further facilitating the quasi-reforming transformation due to the reforming catalytic layer 144.

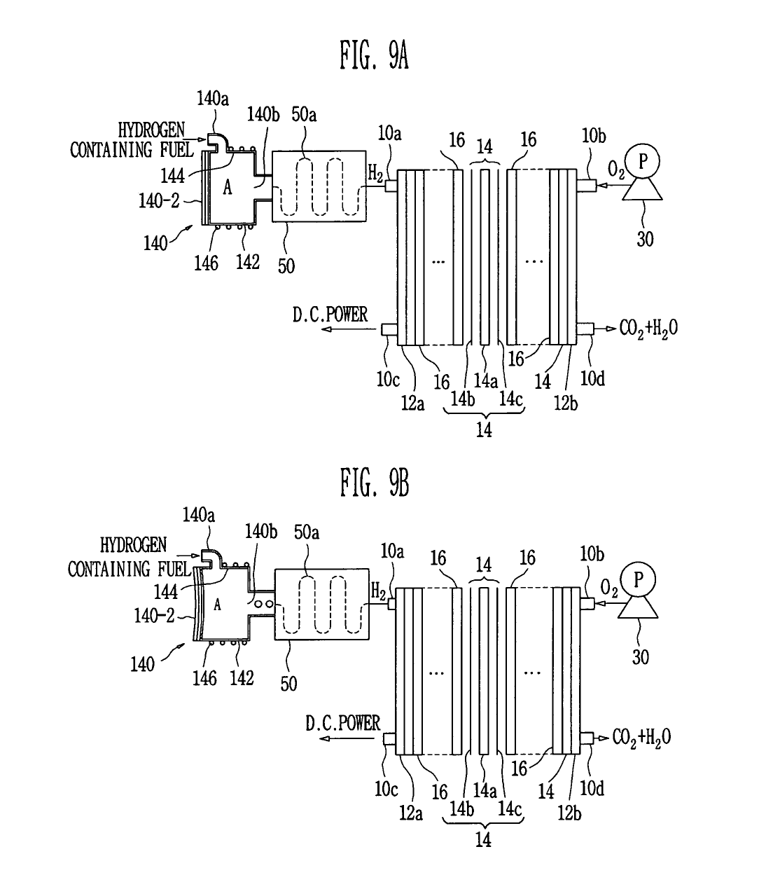

Referring to FIGS. 9A-9B, the PEMFC includes the injection nozzle assembly 140 between the fuel storage tank 20 and the reformer 50, which employs the piezo actuator 140-2 as an injection means. Therefore, when an electric signal is transmitted from the controller (not shown) to the piezo actuator 140-2, the piezo actuator 140-2 is deformed, discharging hydrogen-containing fuel accommodated in the fuel chamber A through the outlet 140b and supplying the hydrogen-containing fuel to the reformer 50. Further, when the hydrogen-containing fuel is discharged to the reformer 50, the hydrogen-containing fuel is supplied from the fuel storage tank 20 to the fuel chamber A by capillary and inertia effects or the like proportionally to the amount of the discharged hydrogen-containing fuel.

The hydrogen-containing fuel maintained in the quasi-reforming state by the quasi-reforming transformation of the reforming catalytic layer 144 is supplied to the inside of the reformer 50 so that the reforming work for the hydrogen-containing fuel flowing in the channel 50 of the reformer 50 may be performed smoothly. Further, when a controller turns on the heating means 146, the hydrogen-containing fuel accommodated in the fuel chamber A is heated, thereby further facilitating the quasi-reforming transformation due to the reforming catalytic layer 144. As the hydrogen-containing fuel is reformed while flowing in the channel 50a of the reformer 50, the generated hydrogen gas is discharged to the stack 10 through the outlet of the reformer 50.

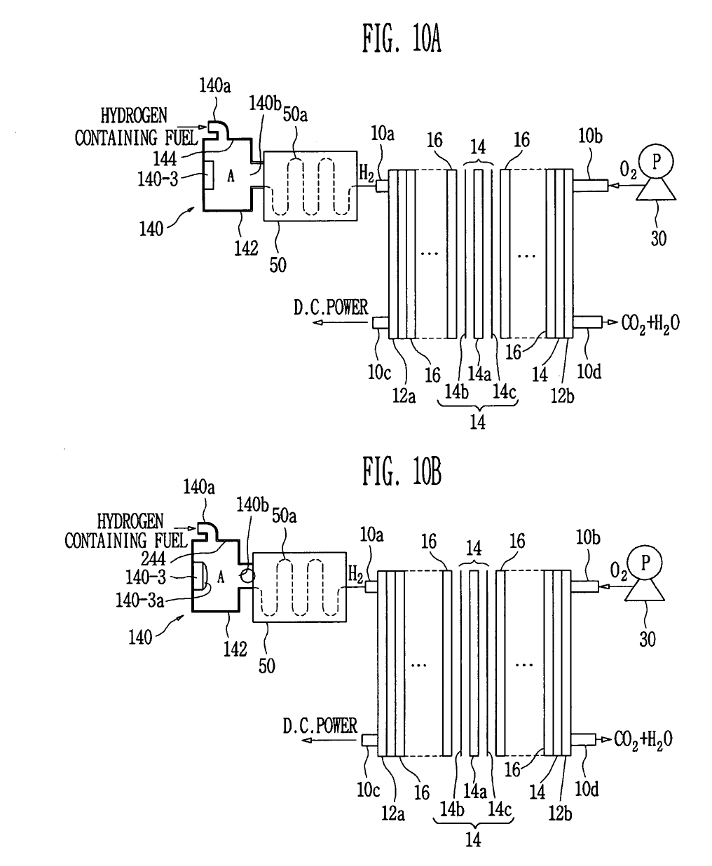

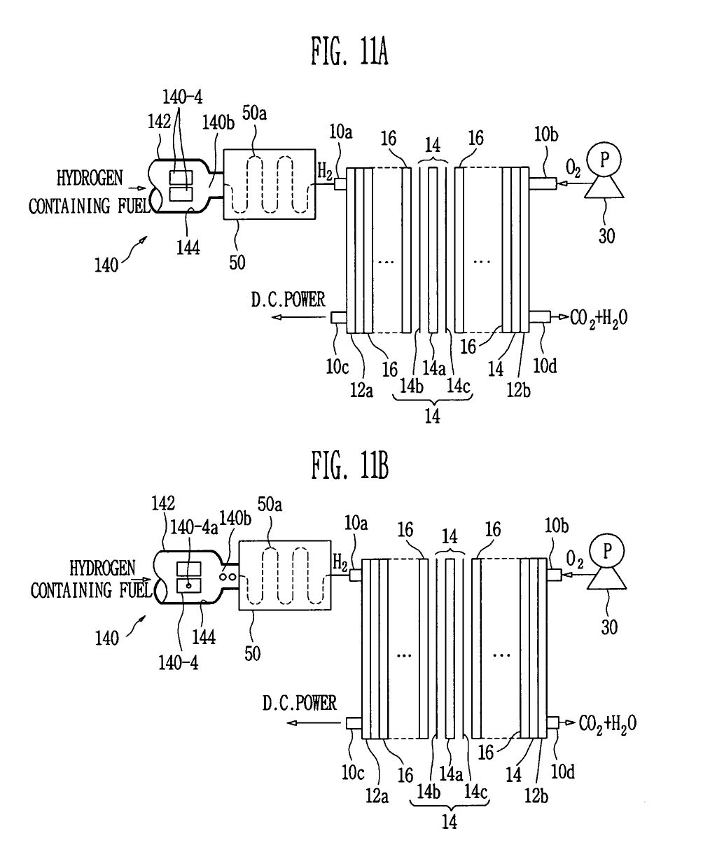

Referring to FIGS. 10A-10B, the injection nozzle assembly 140 provided between the inlet of the reformer 50 and the fuel storage tank 20 employs a heater 140-3 as the injection means. Therefore, when an electric signal is transmitted from the controller to the heater 140-3, the heater 140-3 is quickly heated, causing the hydrogen-containing fuel accommodated in the fuel chamber A to generate gas bubbles 140-3a. Due to the expansion of the gas bubbles 140-3a, the hydrogen-containing fuel is discharged toward the reformer 50 through the outlet 140b. Thus, such injected liquid fuel is supplied to the inside of the reformer 50 via the inlet of the reformer. Further, when the gas bubbles are condensed after discharging the hydrogen-containing fuel, the hydrogen-containing fuel is introduced from the fuel storage tank 20 into the fuel chamber A through the inlet 140a proportionally to the amount of the discharged hydrogen-containing fuel.

The hydrogen-containing fuel supplied to the inside of the reformer 50 is maintained in the quasi-reforming state by the quasi-reforming transformation of the reforming catalytic layer 144, so that the reforming work for the hydrogen-containing fuel is performed smoothly while the fuel is flowing in the channel 50 of the reformer 50. Further, the hydrogen gas generated at this time is discharged to the stack 10 through the outlet of the reformer. In particular, the heater 140-3 is heated by the external power supplied by the controller and then heats the hydrogen-containing fuel accommodated in the fuel chamber A, thereby further facilitating the quasi-reforming transformation due to the reforming catalytic layer 144.

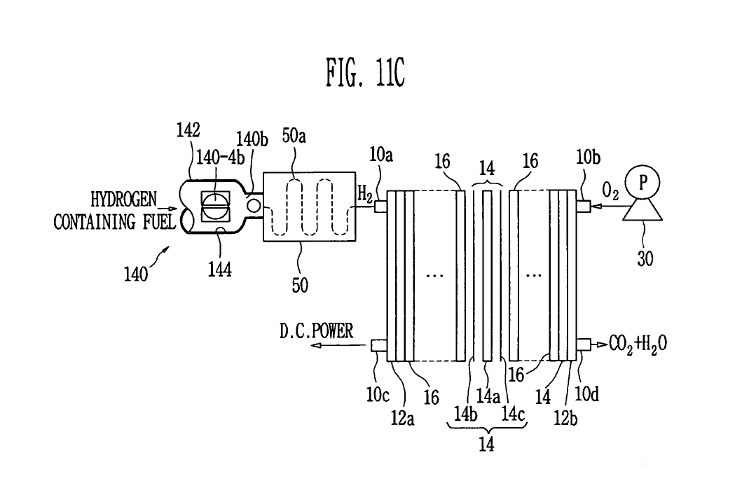

Referring to FIGS. 11A-11C, the injection nozzle assembly 140 includes a housing, i.e., a connection pipe 142 connecting the fuel storage tank 20 with the reformer 50 without a separate fuel chamber. The connection pipe 142 employs a heating plate 140-4 as the injection means thereinside. Further, the inside of the connection pipe 142 is coated with a reforming catalytic layer 144 to transform the hydrogen-containing fuel into a quasi-reforming state. Therefore, when an electric signal is transmitted from the controller to the heating plate 140-4, the heating plate 140-4 is heated and thus the hydrogen-containing fuel expands and generates gas bubbles 140-4a, 140-4b. The hydrogen-containing fuel is discharged toward the inlet of the reformer 50 through the outlet 140b proportionally to the volume of the generated gas bubbles 140-4a, 140-4b. On the other hand, when the heating plate 140-4 is cooled when the external power is turned off, the hydrogen-containing fuel is introduced from the fuel storage tank 20 to the inside of the connection pipe 142 proportionally to the reduced volume thereof.

Also, as the hydrogen-containing fuel is reformed while flowing in the channel 50a of the reformer 50, the generated hydrogen gas is discharged to the stack 10 through the outlet of the reformer 50.

As described above, the hydrogen gas generated in the reformer 50 is introduced to the first inlet 10a of the stack 10 through the outlet of the reformer 50. The hydrogen gas introduced in the first inlet 10a is supplied to the anode electrode 14b of the MEA 14 through the hydrogen gas inlet (not shown) and the hydrogen gas channel (not shown) formed in the first side of the bipolar plate 16 as well as the hydrogen gas channel formed in the first end plate 12a. Thereafter, the hydrogen gas is dissolved into the hydrogen ion (proton) and the electron through the oxidation in the catalytic layer of the anode electrode 14b

Meanwhile, as the air pump 30 is operated, oxygen gas in the air introduced in the second inlet 10b of the stack 10 is supplied to the cathode electrode 14c of the MEA 14 through the oxygen gas inlet (not shown) and the oxygen gas channel (not shown) formed in the second side of the bipolar plate 16 as well as the oxygen gas channel formed in the second end plate 12b. Thereafter, the oxygen gas is dissolved into the oxygen ion and the electron in the catalytic layer of the cathode electrode 14c.

The hydrogen ion generated in the anode electrode 14b is transferred to the cathode electrode 14c through the polymer membrane 14a, and then reacted with the oxygen ion generated in the cathode electrode 14c by the oxygen reduction, thereby generating water.

Then, the generated water along with carbon dioxide or the like generated in the stack 10 is discharged to the outside through the discharging portion 10d provided in the second end plate 12b. Further, the electron generated in the anode electrode 14b is collected in the electric collector (not shown), and then outputted to the outside circuit through the output terminal 10c provided in the first end plate 12a.

While the invention has been described in connection with certain exemplary embodiments, it is to be understood by those skilled in the art that the invention is not limited to the disclosed embodiments, but, on the contrary, is intended to cover various modifications included within the sprit and scope of the appended claims and equivalents thereof.

What is claimed is:

1. A fuel cell system comprising:
a stack provided with a plurality of unit cells generating electricity based on a chemical reaction between hydrogen gas and oxygen gas;
a reformer for supplying the hydrogen gas obtained by reforming hydrogen-containing fuel to the stack;
a fuel storage tank for storing the hydrogen-containing fuel to be supplied to the reformer;
an air supplier for supplying air to the stack; and
an injection nozzle assembly provided for fluid communication between the fuel storage tank and the reformer,
wherein the injection nozzle assembly includes a housing that defines a fuel chamber to accommodate the hydrogen-containing fuel supplied from the fuel storage tank, the housing having a first side formed with an outlet through which the hydrogen-containing fuel accommodated in the fuel chamber is discharged, and an injection means provided in the fuel chamber.

2. The fuel cell system according to claim 1, further comprising a reforming catalytic layer coated on an inside of the housing.

3. The fuel cell system according to claim 1, further comprising a reforming catalytic layer coated on an inside of the outlet.

4. The fuel cell system according to claim 1, wherein the injection means includes an externally powered vibration plate.

5. The fuel cell system according to claim 2, wherein the injection means comprises an externally powered vibration plate.

6. The fuel cell system according to claim 3, wherein the injection means comprises an externally powered vibration plate.

7. The fuel cell system according to claim 1, wherein the injection means includes an externally powered piezo actuator.

8. The fuel cell system according to claim 2, wherein the injection means comprises an externally powered piezo actuator.

9. The fuel cell system according to claim 3, wherein the injection means comprises an externally powered piezo actuator.

10. The fuel cell system according to claim 1, wherein the injection means includes a heater generating gas bubbles in the hydrogen-containing fuel.

11. The fuel cell system according to claim 2, wherein the injection means comprises a heater generating gas bubbles in the hydrogen-containing fuel.

12. The fuel cell system according to claim 3, wherein the injection means comprises a heater generating gas bubbles in the hydrogen-containing fuel.

13. The fuel cell system according to claim 1, wherein the housing includes a connection pipe, and wherein the injection means includes a heating plate to generate gas bubbles in the hydrogen-containing fuel accommodated within the connection pipe.

14. The fuel cell system according to claim 2, wherein the housing comprises a connection pipe, and wherein the injection means comprises a heating plate generating gas bubbles in the hydrogen-containing fuel accommodated within the connection pipe.

15. The fuel cell system according to claim 3, wherein the housing comprises a connection pipe, and wherein the injection means comprises a heating plate generating gas bubbles in the hydrogen-containing fuel accommodated within the connection pipe.

16. The fuel cell system according to claim 1, wherein the hydrogen-containing fuel includes a hydro-carbonaceous material such as ethanol, methanol or natural gas.

17. The fuel cell system according to claim 2, wherein the hydrogen-containing fuel includes a hydro-carbonaceous material such as ethanol, methanol or natural gas.

18. The fuel cell system according to claim 3, wherein the hydrogen-containing fuel includes a hydro-carbonaceous material such as ethanol, methanol or natural gas.

19. The fuel cell system according to claim 1, further comprising a heating means provided in the housing.

20. The fuel cell system according to claim 19, wherein the heating means includes a hot wire.

21. The fuel cell system according to claim 2, further comprising a heating means provided in the housing.

22. The fuel cell system according to claim 21, wherein the heating means comprises a hot wire.

23. The fuel cell system according to claim 3, further comprising a heating means provided in the housing.

24. The fuel cell system according to claim 23, wherein the heating means comprises a hot wire.

25. The fuel cell system according to claim 1, wherein the housing includes a connection pipe, and wherein the injection means includes a heating plate installed in the connection pipe.

26. The fuel cell system according to claim 2, wherein the housing comprises a connection pipe, and wherein the injection means comprises a heating plate installed in the connection pipe.

27. The fuel cell system according to claim 3, wherein the housing comprises a connection pipe, and wherein the injection means comprises a heating plate installed in the connection pipe.

28. The fuel cell system according to claim 2, wherein the reforming catalytic layer includes at least one catalytic material selected from a group consisting of Pt, Pd, Ru, Rh, Ir, Cu, Cr, Mo, W and Co.

29. The fuel cell system according to claim 3, wherein the reforming catalytic layer includes at least one catalytic material selected from a group consisting of Pt, Pd, Ru, Rh, Ir, Cu, Cr, Mo, W and Co.
